(19) United States
(12) Patent Application Publication
(10) Pub. No.: US 2008/0244981 A1
(43) Pub. Date: Oct. 9, 2008

(54) Window clamp assembly for window regulator

(75) Inventor: Shigeki Arimoto, Bloomfield, MI (US)

Correspondence Address: BRINKS HOFER GILSON & LIONE, P.O. BOX 10395, CHICAGO, IL, 60610, US

(73) Assignee: Hi-Lex Controls, Inc.

(21) Appl. No.: 11/784,595

(22) Filed: Apr. 9, 2007

(51) Int. Cl. E05F 11/48

(52) U.S. Cl. 49/352

(57) ABSTRACT

A window clamp assembly for an automotive window regulator assembly. In the clamp assembly of this invention, a lower edge of the motor vehicle window features a rounded tapered bottom edge with an adjacent aperture. A window clamp is provided which forms a window engaging slot having a generally V-shaped bottom surface which cooperates with the window lower edge to properly position the window relative to the clamp. During assembly, a tab of the clamp engages with the window hole to fasten it in position. The design facilitates rapid assembly of the components by reducing the accuracy needed in the positioning of the two parts during their assembly.

### FIELD OF THE INVENTION

This invention relates to a window clamp assembly used as a component of a window regulator for automotive vehicles.

### BACKGROUND OF THE INVENTION

Automobiles generally feature side door glass which can be moved between lower-opened and upper-closed positions. A window regulator is used to support and move the glass between these positions. Window regulators require some means for mounting or attachment to the window glass (or other glazing material) to structurally engage it to control its position. Window regulators often include a window clamp which attaches at the lower edge of the glass through various approaches. One approach uses a clamp which pinches the glass for attachment. Another type inter-engages with a hole through the glass formed near the lower edge of the glass. In the conventional designs of the above-mentioned window glass clamp which fastens through a hole in the glass, it is necessary during its assembly for an operator to accurately position the clamp and force it into engagement with the window at the proper position such that an interlocking feature engages with the window glass hole. The necessity of accurately positioning the clamp in this manner gives rise to assembly difficulties and potential improper assembly situations. This invention is related to a window clamp assembly for a window regulator which enables efficient and reliable assembly using features which locate the clamp relative to the preformed window attachment hole.

Additional benefits and advantages of the present invention will become apparent to those skilled in the art to which the present invention relates from the subsequent description of the preferred embodiment and the appended claims, taken in conjunction with the accompanying drawings.

### BRIEF DESCRIPTION OF THE DRAWINGS

FIG. 1 is a pictorial view of a window regulator for an automobile including a pair of clamp assemblies in accordance with this invention;

FIG. 2 is a pictorial view of a clamp in accordance with this invention shown without an optional spacer clip;

FIG. 3 is a pictorial view of a spacer clip for use with the window clamp in accordance with this invention;

FIG. 4 is a pictorial view of the spacer clip installed into the window clamp which is affixed to a window;

FIG. 5 is a pictorial view of a clamp assembly in accordance with this invention shown attached to a window glass as in FIG. 4 but showing some of the features of the clip in phantom lines; and

FIG. 6 through 8 are partial detailed views of the connection between the window glass and clip tab when connected with the window, showing that a range of window hole lateral positions are accommodated.

### DETAILED DESCRIPTION OF THE INVENTION

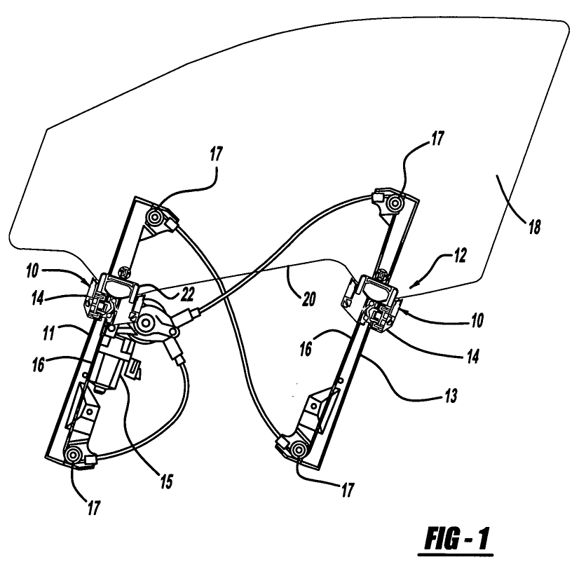

FIG. 1 illustrates a window regulator 12 incorporating features in accordance with this invention. Window regulator 12 is shown as a representative unit which is used to raise and lower window 18. As shown, window regulator 12 incorporates a pair of slide channels 11 and 13. A pair of window clamps 14 are provided which engage with slide channels 11 and 13 and move between upper and lower positions to move the window 18. Window regulator 12 is designed to be mounted inside the hollow portion of an automobile door. An electric motor 15 operates through a pulley system to drive cables 16 attached to the clamps to move them between their positions. Cables 16 are guided by cable pulleys 17. The window regulator 12 design illustrated in FIG. 1 is merely illustrative of one of a number of types of window regulators which could incorporate the features of the present invention.

FIGS. 2 through 5 illustrate the primary components of window clamp assembly 10 in accordance with this invention which includes clamp 14 engaged with window 18. As shown in FIG. 4, window 18 in accordance with this invention features a lower edge 20 forming a pointed rounded edge section 22 with aperture or hole 24 positioned above the rounded edge section. While pointed edge section 22 is shown and described herein, other configurations of a formed lower edge section could be used to locate clamp assembly 10.

FIG. 2 shows additional details of clamp 14. As shown, clamp 14 is preferably formed as an injection molded polymer plastic part and features a U-shaped bridge section 30 having a protruding tab 32 located at its top center. U-shaped bridge 30 connects with the remainder of the clamp 14 at its lower legs 31 and 33. Clamp 14 forms a slot 34 formed by bridge section 30 and upstanding wall 36 which receives window 18. Clamp 14 further forms one or more grooves 35 with tabs 38 for engaging one of side channels 11 and 13. Cable termination sockets 40 are provided for engaging a pair of cable ends which drive clamp 14 along the associated guide channels 11 or 13.

In accordance with a principal feature of this invention, slot 34 has a formed shape to engage with the formed window lower edge, in the case of the described embodiments, the slot has a V-shaped bottom surface 37 defined in part by projecting shoulders 42 which guides window 18 into a proper registered position with clamp 14. Shoulders 42 project from bridge section 30 and cooperate with V-shaped bottom surface 37 which receives window pointed edge section 22. During assembly of clamp 14 onto window 18, pointed edge section 22 is inserted within slot 34 and shoulders 42 guide the rounded edge section 26 into its proper position, bottomed out within the channel bottom surface 37. In this position, tab 32 snaps into window hole 24. The cooperation of pointed edge section 22 and slot 34 with the V-shaped bottom surface 37 allows an operator to assemble these parts during fabrication without precisely locating them in the fore-and-aft direction along the window lower edge 20. The cooperation of the pointed edge 22 of the window and clamp slot 34 locates these parts in proper registry with one another to enable the rapid snap attachment assembly to occur.

The U-shaped bridge 30 provides a relative long cantilever supported pair of bending legs 31 and 33 which provides a spring-like deflection movement of tab 32 which facilitates the assembly and, if necessary, detachment of the clamp 14 from the window 18. Tab 32 has a sloped leading edge 46 to cause it to deflect as window 18 is inserted during assembly. During assembly, slot 34 widens during insertion of window 18, causing bending deflection of legs 31 and 33.

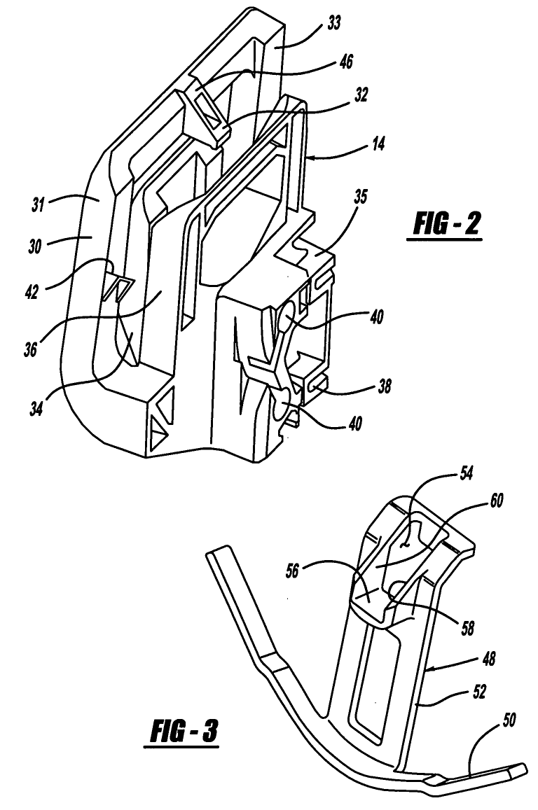

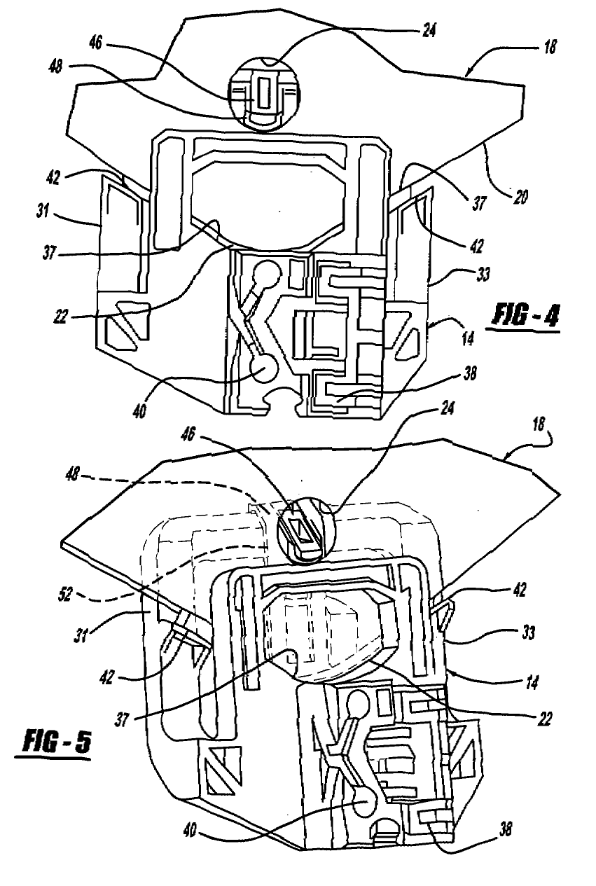

As a means of reducing the likelihood of component rattling, spacer clip 48 may be provided which is illustrated in FIG. 3. Spacer clip 48 includes a lower window edge strip 50 which, when the clip is positioned within clamp channel 34, acts like a gasket, filling the gap between window lower pointed edge 22 and the bottom surface 37 of slot 34 and shoulders 42. Clip 48 further includes an upwardly extending arm 52 which inter-engages with tab 32. Clip 48 is preferably formed of a relatively soft and compressive polymeric material which will enable a range of tolerance variations in the assembly of window 18 with clamp 14 to occur, while preventing these parts from rattling through looseness in their connection. The incorporation of spacer clip 48 is illustrated in FIG. 5 which shows the clip installed onto clamp 14. The upper portion of clip arm 52 includes an aperture 54 which receives tab 32. The aperture 54 further includes wall surfaces including bottom wall 56 and side walls 58 and 60. Walls 56, 58, and 60 envelope the bottom and sides of tab 32 to act as a gasket between the remainder of clamp 14 in its engagement with window 18.

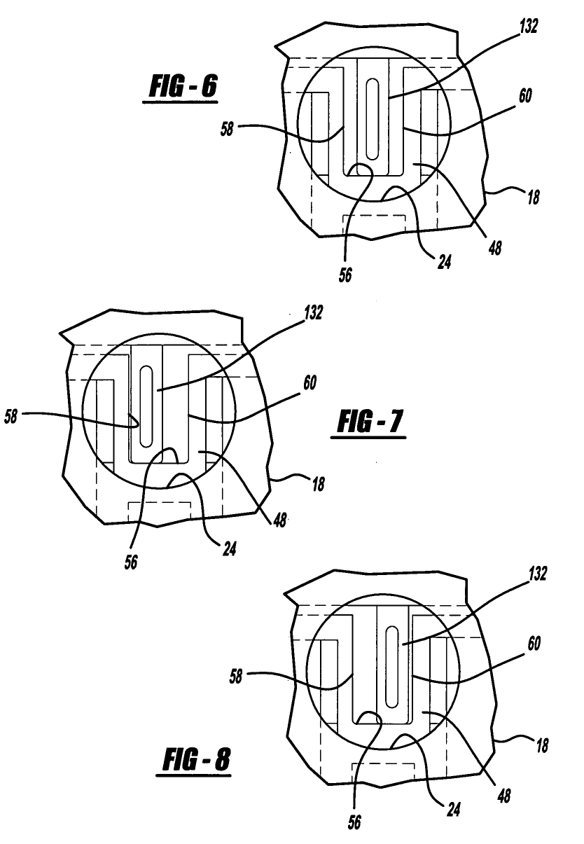

Now with reference to FIGS. 6, 7, and 8, a feature in accordance with an alternate embodiment of this invention is disclosed. This embodiment differs in the connection between spacer clip 48, clamp 14, and window 18. In this embodiment, bridge section tab 132 which protrudes from clamp bridge section 30 is narrower than the aperture 54 formed by spacer clip 48. As shown in FIG. 6, tab 132 is positioned within aperture 54 leaving spaces in the left and right hand directions as the parts are illustrated in FIG. 6. FIG. 7 shows a slightly different orientation of the parts assembled to a different representative window. In this case, tab 132 is moved to the left-hand side of aperture 54, and in FIG. 8, the tab 132 is moved to the right-hand edge of aperture 54. These FIGS. 6, 7, and 8 illustrate that a tolerance range in the positioning of window hole 24 relative to rounded lower window edge 22 can be accommodated through this configuration of spacer clip 48 and tab 32. In all of the respects, the embodiment illustrated in FIGS. 6 through 8 operates in the manner described previously.

While the above description constitutes the preferred embodiment of the present invention, it will be appreciated that the invention is susceptible to modification, variation and change without departing from the proper scope and fair meaning of the accompanying claims.

1. A window clamp assembly for an automotive window regulator for moving a window between opened and closed positions, the window clamp assembly comprising:
the window having a lower edge having a formed edge section and a hole positioned at a predetermined location relative to the formed edge section, and
a window clamp having surfaces forming a window engaging slot with a formed bottom surface, and further forming an engagement tab, the window engaging slot engaging with the window formed edge section to guide the formed edge section to a seated position with the formed bottom surface wherein the engagement tab interlocks with the window hole.

2. A window clamp assembly according to claim 1, wherein the window formed edge section is pointed, and the window clamp bottom surface is V-shaped to conform with the pointed window edge section.

3. A window clamp assembly according to claim 2 wherein the bridge section forms at least one shoulder which forms a part of the V-shaped bottom surface.

4. A window clamp assembly according to claim 1 wherein the window clamp further forms a bridge section with a center section forming the engagement tab, the bridge section being cantilever supported to allow deflection of the engagement tab.

5. A window clamp assembly according to claim 1 wherein the window clamp further forms a groove for allowing the window clamp to slide along a window regulator slide channel.

6. A window clamp assembly according to claim 1 wherein the window clamp further forming at least one socket for receiving a cable end for moving the clamp along a window regulator guide channel.

7. A window clamp assembly according to claim 1 further comprising a spacer clip positioned within the window engaging slot and positioned between the window formed edge section and the window clamp window engaging channel.

8. A window clamp assembly according to claim 7 wherein the spacer clip further forms an arm and an aperture for receiving the clip tab.

9. A window clamp assembly according to claim 8 wherein the spacer clip further forms a bottom wall and a pair of side walls forming the aperture and positioned between the edges defining the widow aperture and the clamp tab.

10. A window clamp assembly according to claim 1 wherein the aperture has a lateral width exceeding the lateral width of the clamp tab wherein the clamp can be assembled with the window having a range of positions of the widow aperture.

11. A window clamp assembly for an automotive window regulator for moving a window between opened and closed positions, the window clamp assembly comprising:
the window having a lower edge forming a pointed edge section and a hole positioned at a predetermined location relative to the pointed edge section, and
a window clamp having surfaces forming a window engaging slot with a v-shaped bottom surface, and forming a bridge section with a center section forming an engagement tab, the bridge section being cantilever supported to allow deflection of the engagement tab, the window engaging slot engaging with the window pointed edge section to guide the pointed section to a seated position with the v-shaped bottom surface wherein the engagement tab interlocks with the window hole.

12. A window clamp assembly according to claim 11 wherein the bridge section forms at least one shoulder which forms a part of the V-shaped bottom surface.

13. A window clamp assembly according to claim 11 wherein the window clamp further forms a groove for allowing the window clamp to slide along a window regulator slide channel.

14. A window clamp assembly according to claim 11 wherein the window clamp further forming at least one socket for receiving a cable end for moving the clamp along a window regulator guide channel.

15. A window clamp assembly according to claim 11 further comprising a spacer clip positioned within the window engaging slot and positioned between the window rounded edge section and the window clamp window engaging channel.

16. A window clamp assembly according to claim 15 wherein the spacer clip further forms an arm and an aperture for receiving the clip tab.

17. A window clamp assembly according to claim 16 wherein the spacer clip further forms a bottom wall and a pair of side walls forming the aperture and positioned between the edges defining the widow aperture and the clamp tab.

18. A window clamp assembly according to claim 11 wherein the aperture has a lateral width exceeding the lateral width of the clamp tab wherein the clamp can be assembled with the window having a range of positions of the widow aperture.
